(19) United States
(12) Patent Application Publication
(10) Pub. No.: US 2010/0214445 A1
(43) Pub. Date: Aug. 26, 2010

(54) IMAGE CAPTURING METHOD, IMAGE CAPTURING APPARATUS, AND COMPUTER PROGRAM

(75) Inventor: Fredrik CHRONQVIST, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/389,615

(22) Filed: Feb. 20, 2009

(51) Int. Cl. H04N 5/76; H04N 5/232; H04N 5/262

(52) U.S. Cl. 348/231.99; 348/347; 348/240.3; 348/E05.031; 348/E05.045; 348/E05.055

(57) ABSTRACT

An image capturing apparatus is disclosed. The apparatus comprises optics for forming an image on an image plane; an image sensor arranged at the image plane and arranged to transform the image to an image signal to form an initial image; an image analyzer arranged to receive the image signal, to find at least one object in the initial image, and to determine at least one zoom area for each found object; an image cut generator arranged to define a result image to comprise at least one of the at least one determined zoom areas; and a storage memory arranged to store the defined result image. A method and computer program for the apparatus are also disclosed.

### TECHNICAL FIELD

The present invention relates to an image capturing method, an image capturing apparatus, and a computer program for image capturing. In particular, the invention relates to determination of suitable zoom areas of an image.

### BACKGROUND

Digital photography has provided photographers a number of new features compared to traditional “chemical” photography. One of the features digital photography has provided is the ability to check the result instantly after an image is captured. Another feature is the ability to delete captured images that do not fulfill the demands of the photographer, and thereby give room for further images in the memory where the images are stored. This, together with ability to store a significant amount of images in the memory, has changed image capturing such that a large number of images are captured, and from which the ones fulfilling the demands of the photographer are kept, and the others may be discarded.

The photographer is provided a number of aids from a modern camera, such as autofocus, automatic exposure, image stabilizer, etc. Many of these features are now also available for cameras in the consumer segment, enabling more simple image capturing and resulting in improved results especially for the amateur photographer.

Still, image capturing relies on traditional photographer's skills in selecting angle of view, composition, perspective, lighting of the scene, etc. It is therefore a desire to further facilitate image capturing and enable further improved image capturing.

### SUMMARY

The present invention is based on the understanding that image composition can be aided during image capturing. The invention is further based on the understanding that pattern recognition is feasible for “electronic photography”, such as in digital cameras. The inventor has found that based on recognised patterns, it is feasible to determine one or more image compositions forming sub-areas, or zoom areas, of an optical image projected on an image sensor. Further features in addition to mere zooming can also be enabled by the suggested approach, such as aid for image capturing direction and application of composition rules.

According to a first aspect, there is provided a method for image capturing, the capturing comprising transforming an optical image into an image signal to form an initial image; analyzing the image signal, wherein the analyzing comprises finding at least one object of the initial image, and determining at least one zoom area for each found object; defining a result image to comprise at least one of the at least one zoom areas; and storing image data of the defined result image.

The capturing may further comprise presenting image data of the determined at least one zoom areas through a user interface; and receiving a selection of at least one of the at least one zoom areas through the user interface, wherein the defining of the result image is made according to the selection. The presenting may comprise enabling of browsing among image data of the determined at least one zoom areas. Alternatively, the presenting may comprise presenting the initial image of the image signal with indications on the determined at least one zoom areas.

The capturing may further comprise selecting at least one of the at least one zoom areas based on a focusing parameter of a focusing mechanism of optics forming the optical image, wherein the defining of the result image is made according to the selection.

The defining may comprise defining result images of each of the determined at least one zoom areas.

The storing may further comprise encoding the result image.

The defining of the result image may comprise any of optical zooming, digital zooming, cropping, and providing instructions to a user to adjust image capturing direction.

The determining of the zoom area may comprise applying a composition rule to the at least one object found in the initial image.

According to a second aspect, there is provided an image capturing apparatus comprising optics for forming an image on an image plane; an image sensor arranged at the image plane and arranged to transform the image to an image signal; an image analyzer arranged to receive the image signal forming an initial image, to find at least one object in the initial image, and to determine at least one zoom area for each found object; an image cut generator arranged to define a result image to comprise at least one of the at least one determined zoom areas; and a storage memory arranged to store image data of the defined result image.

The apparatus may further comprise a user interface, wherein the user interface is arranged to present image data of the determined at least one zoom areas, and to receive a selection of at least one of the at least one zoom areas, such that the image cut generator is enabled to define the result image according to the selection.

The optics may comprise a focusing mechanism arranged to determine at least one object in the initial image on which focus settings are calculated, and to adjust focus of the optics according to the focus settings, wherein the apparatus further comprises a selection mechanism arranged to make a selection of at least one of the at least one zoom areas based on the object(s) on which the focus settings are calculated, such that the storage memory is enabled to store the result image according to the selection.

The optics may comprise a focusing mechanism, and wherein the image analyzer is further arranged to provide a focusing parameter to the focusing mechanism for controlling the focusing mechanism, wherein the focusing parameter is based on object(s) found by the image analyzer.

The optics may comprise an optical zoom mechanism, and the image analyzer may further be arranged to provide an optical zoom parameter to the optical zoom mechanism for controlling the optical zoom mechanism, wherein the optical zoom parameter is based on object(s) found by the image analyzer.

The image cut generator may be arranged to control any of an optical zoom, a digital zoom, an image crop mechanism, and a user interface arranged to provide instructions to a user to adjust image capturing direction.

According to a third aspect, there is provided a computer readable medium comprising a computer program comprising instructions, which when executed on a processor cause the processor to perform image capturing according to the first aspect.

### BRIEF DESCRIPTION OF DRAWINGS

FIG. 1 is a block diagram schematically illustrating an image capturing apparatus according to an embodiment.

FIGS. 2a to 2c illustrate situations where the invention is applied.

FIG. 3 is a flow chart illustrating a method according to an embodiment.

FIG. 4 schematically illustrates a computer-readable medium comprising a computer program according to an embodiment.

### DETAILED DESCRIPTION

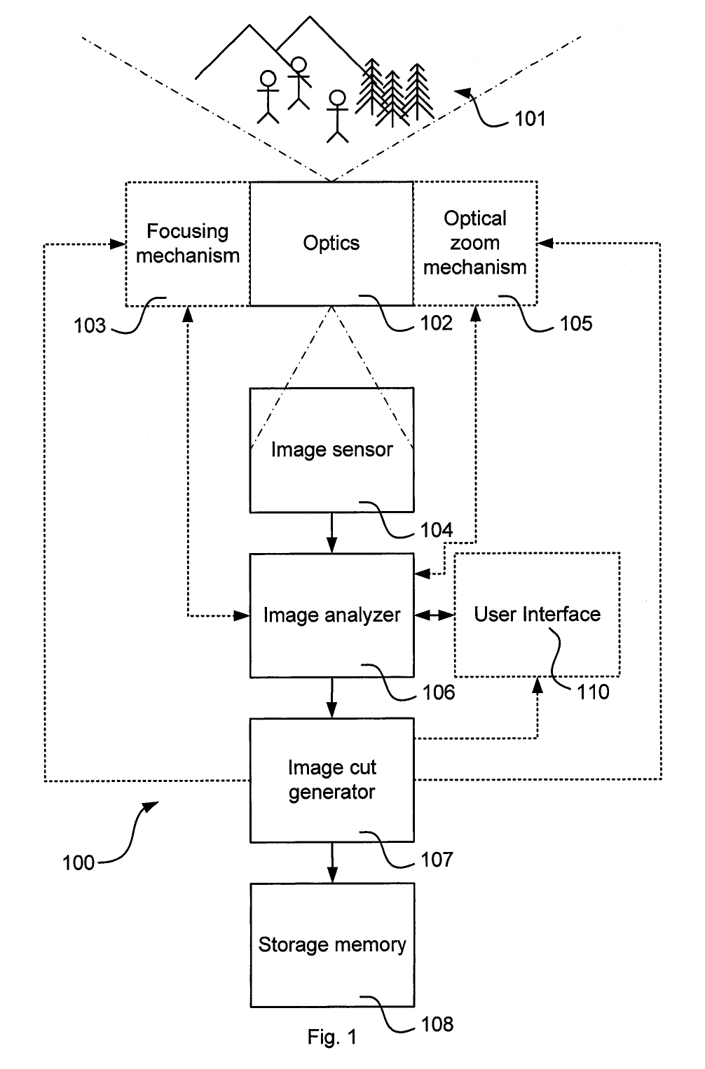

FIG. 1 is a block diagram schematically illustrating an apparatus 100 for image capturing, such as a camera or other apparatus with camera feature. The apparatus 100 comprises optics 102 for projecting an image of a scene 100 on an image sensor 104. The image sensor is arranged to transform the projected image into an image signal. The image sensor 104 can typically be a charge-coupled device (CCD) or a complementary metal-oxide-semiconductor (CMOS) active-pixel sensor. The apparatus 100 preferably also comprises means for digitizing the image signal, which means can be included in the image sensor 104, in an image analyzer 106, or in a separate circuit. The image signal is provided to the image analyzer 106, which is arranged to find at least one object of the image, i.e. among objects present in the imaged scene 101. This is preferably performed by image processing for recognizing objects, i.e. pattern recognition, e.g. faces, eyes, symbols, etc. The image analyzer is further arranged to determine one or more suitable zoom areas associated with found objects. For example, if a face is found, a zoom area including the face and its closest surrounding can be determined. Further, as the face is found, pattern recognition mechanism can analyze the image to find a body connected to the face. If that is found, a further zoom area can include the face and the body of a person. If several persons are found in the image, further zoom areas including a group of the persons can be determined. Similar, if for example one or more symbols are found, e.g. a sign, it can be determined as a zoom area, and if a person and the sign is found, a further zoom area including the sign and the person can be determined as a further zoom area. If e.g. bounds of a face is hard to determine, but eyes can be found by the pattern recognition mechanism, the zoom area or areas can be predicted from the position of the eyes and their mutual distance. The pattern recognition mechanism can benefit from a look-up table comprising pattern blocks to correlate to, e.g. for increasing speed and/or decreasing required processing power. Further input to the image analysis can be provided by exchanging information with a focusing mechanism 103 and/or an optical zoom mechanism. When one or more zoom areas are determined, image data from the image signal of the zoom area(s), optionally after a selection of zoom area(s), is provided to an image cut generator 107. The image cut generator 107 is arranged to define one or more result images. The defining can for example be controlling optical and/or digital zoom level. The zooming adjustment can be both zooming in and zooming out, as will be understood from application examples presented below. The image cut generator 107 can also control cropping of the image, or even provision of instructions to a user to for example adjust the direction for image capturing, e.g. arrows indicating to adjust left and up, via a user interface 110. Here, the image analyzer 106 can apply some composition rules which are commonly used in aesthetic photography, such as rule of thirds, golden cut, diagonal object distribution, etc. Based on the found, and possibly selected, object(s), a suitable composition rule can be determined, and possibly suggested to the user for selection via the user interface 110, and from that composition, the image cut generator defines the result image, which may imply adjusting optical zoom, focus plane, capturing direction, and/or cropping. Another example is that the image cut generator 107 only makes a cropping for cutting out a desired zoom area. The result image is then stored in a storage memory 108. The term “storage memory” should be construed functionally as any memory where image data is stored such that a user can pick it out at a later time for using the image content, e.g. viewing, sending, printing, etc. Functionally, in contrast to the “storage memory”, the processing where objects are searched, the zoom areas are determined, etc. also requires a memory, but in this context, the temporary storing for the processing is functionally considered as a processing memory which is distinguished from the storage memory. Physically, the same or different memory circuitry can be used for the processing memory and the storage memory. A feasible solution is where the storage memory is a non-volatile memory, while the processing memory is a random access memory. The image data can be encoded before storing with an image compression algorithm, e.g. a lossless compression algorithm such as run-length encoding, differential pulse-code modulation, predictive coding or entropy coding, or lossy compression algorithm such as transform coding, fractal compression or chroma subsampling. Alternatively, the image data is not compressed, and is stored as raw data.

The image analyzer 106 can provide found zoom area(s) to the optional user interface 110, which presents the found zoom area(s) to a user such that the user is enabled to select zoom areas to store. Thus, the user interface 110 is arranged such that the user is enabled to indicate those zoom areas, and the user interface can receive the indication on selection, wherein image data of those zoom areas are defined as result images and stored. The presenting of the found zoom areas can be made such that the user is enabled to browse through the images of the zoom areas, or the zoom areas can be presented as indications in the image of the entire image signal.

The selection of zoom area(s) for storing can alternatively be based on a focusing parameter of the optional focusing mechanism 103 of the optics 102. The focusing parameter can be based on pattern recognition, e.g. face pattern where focus is set to found face patterns in the image. Upon selected focus points upon focusing, information on this is provided from the focusing mechanism 103 to the image analyzer, and found objects associated to these focus points are selected.

Further optionally, the image analyzer 106 can provide control to the optional optical zoom mechanism 105 of the optics 102. The control can comprise adjusting optical zooming, e.g. if found zoom area is a minor area in the center of the image, the optical zoom zooms in to give more available image sensor pixels to the found zoom area. This feature is possible if the image analyzing is made on a preview image, e.g. to be presented in a viewfinder, present before the actual instant of the image capturing. This feature is also possible in connection with an image capturing setting where several images are captured in a sequence for enabling a user to select the one that he finds best. In that case, the different images of the sequence can be taken at different optical zoom settings, which are controlled by the image analyzer. Alternatively, the control is provided by the image cut generator 107 upon defining the result image.

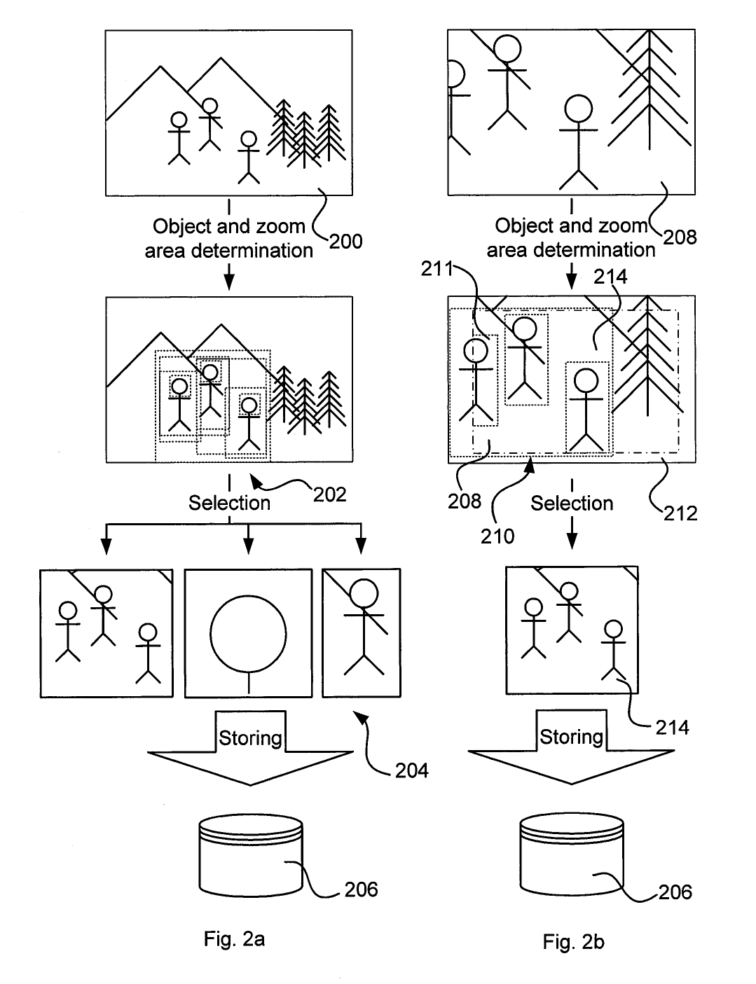

For the understanding of feasible effects of the invention, FIGS. 2a to 2c illustrate situations where the invention is applied. FIG. 2a illustrates a situation where an image 200 is projected on the image sensor and transformed into an image signal. The image analyzer finds a couple of zoom areas 202. Among the zoom areas 202, three of them are selected and image data of the selected zoom areas 204 is stored in the storage memory 206. FIG. 2b illustrates a situation, in which a similar view is used for easy understanding, where the initial image 208 has a few objects 210 that are identified. One of the objects 211 is found to be at a boundary of the initial image 208 and the optical zoom is provided a control signal for zooming out such that a wider view 212 is provided. From this, a zoom area 214 is selected and defined as a result image, which is stored in the storage memory 206. FIG. 2c illustrates a situation where two objects 216 are found, and a zoom area 218 including both the objects is selected. A composition rule, here the third rule of thirds, is applied such that the center of the zoom area 218 is centered at a third spot 220 of an image cut 222, and the image cut generator defines the result image as the image cut 222. The result image is then stored in the storage memory 206.

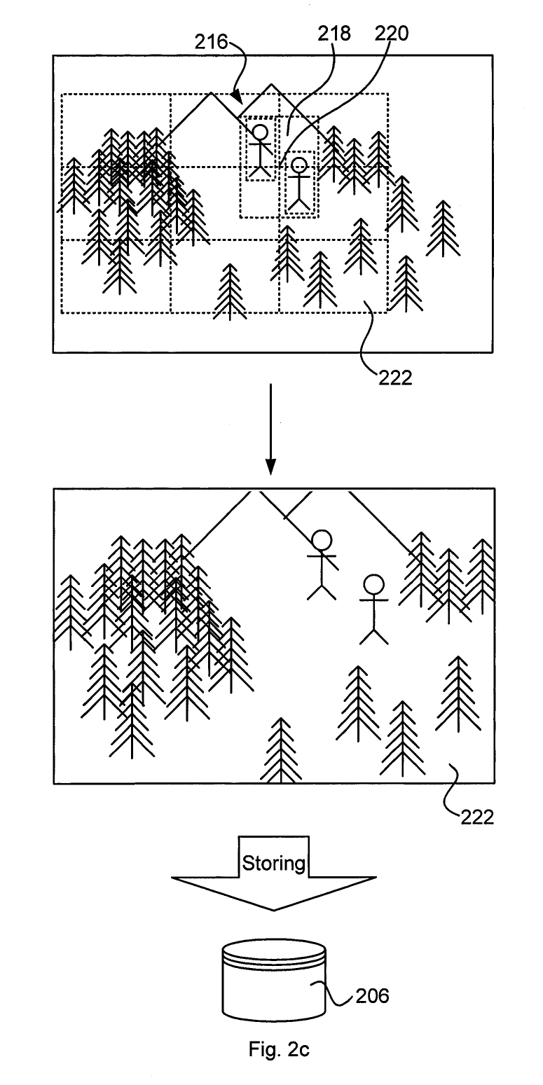

FIG. 3 is a flow chart illustrating a method. In an image signal provision step 300, an optical image projected to an image sensor is transformed into an image signal. In an object determination step 302, the image signal is analyzed to find at least one object of the image. In a zoom area determination step 304, the image signal is analyzed to determine at least one zoom area for each found object. In an optional zoom area selection step 305, one or more of the determined zoom areas are selected for further processing. The selection can be made by user interaction, or based on a focusing parameter, as demonstrated above. The image data from the zoom area(s) or optionally selected zoom areas are used for defining a result image in a result image defining step 306. The defining of the result image can comprise digital and/or optical zooming, application of an image composition rule, cropping, and/or instructions to a user to adjust direction of image capturing. The result image(s) is(are) then stored in a storage memory in an image storing step 308.

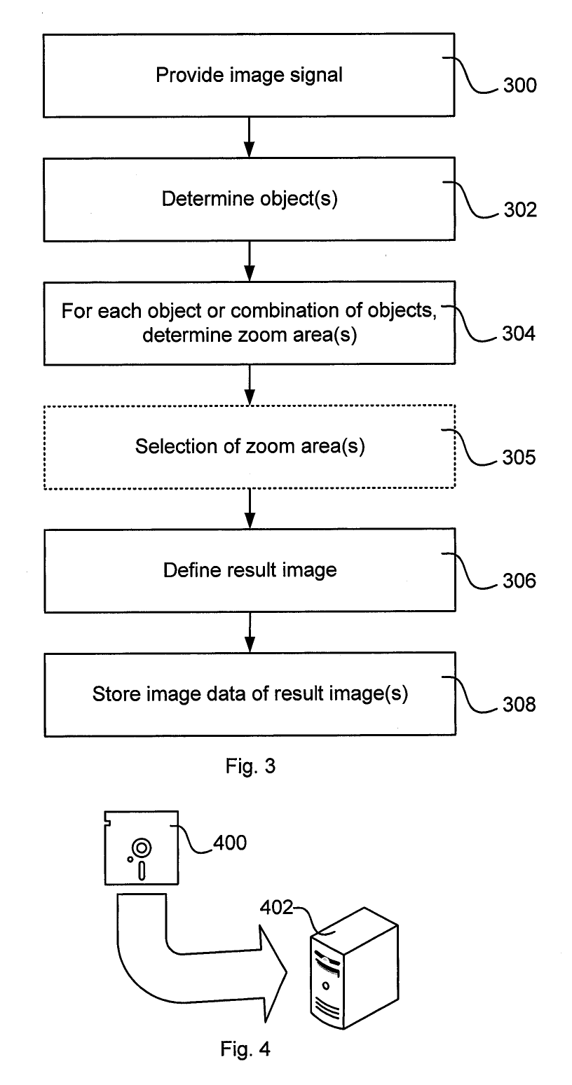

The methods according to the present invention are suitable for implementation with aid of processing means, such as computers and/or processors. Therefore, there is provided computer programs, comprising instructions arranged to cause the processing means, processor, or computer to perform the steps of any of the methods according to any of the embodiments described with reference to FIG. 3, in the apparatus. The computer programs preferably comprises program code which is stored on a computer readable medium 400, as illustrated in FIG. 4, which can be loaded and executed by a processing means, processor, or computer 402 to cause it to perform the methods, respectively, according to embodiments of the present invention, preferably as any of the embodiments described with reference to FIG. 3. The computer 402, which can be present in the apparatus as illustrated in FIG. 1, and computer program product 400 can be arranged to execute the program code sequentially where actions of the any of the methods are performed stepwise, or be performed on a real-time basis, where actions are taken upon need and availability of needed input data. The processing means, processor, or computer 402 is preferably what normally is referred to as an embedded system. Thus, the depicted computer readable medium 400 and computer 402 in FIG. 4 should be construed to be for illustrative purposes only to provide understanding of the principle, and not to be construed as any direct illustration of the elements.

1. A method for image capturing, the capturing comprising
transforming an optical image into an image signal to form an initial image;
analyzing the image signal, wherein the analyzing comprises
finding at least one object of the initial image, and
determining at least one zoom area for each found object;
defining a result image to comprise at least one of the at least one determined zoom areas; and
storing image data of the defined result image.

2. The method according to claim 1, wherein the capturing further comprises
presenting image data of the determined at least one zoom areas through a user interface; and
receiving a selection of at least one of the at least one zoom areas through the user interface,
wherein the defining of the result image is made according to the selection.

3. The method according to claim 2, wherein the presenting comprises enabling of browsing among image data of the determined at least one zoom areas.

4. The method according to claim 2, wherein the presenting comprises presenting the initial image of the image signal with indications on the determined at least one zoom areas.

5. The method according to claim 1, wherein the capturing further comprises selecting at least one of the at least one zoom areas based on a focusing parameter of a focusing mechanism of optics forming the optical image, wherein the defining of the result image is made according to the selection.

6. The method according to claim 1, wherein the defining comprises defining result images of each of the determined at least one zoom areas.

7. The method according to claim 1, wherein the storing further comprises encoding the image data of the result image.

8. The method according to claim 1, wherein the defining of the result image comprises any of:
optical zooming, digital zooming, cropping, and providing instructions to a user to adjust image capturing direction.

9. The method according to claim 1, wherein the determining of the zoom area comprises applying a composition rule to the at least one object found in the initial image.

10. An image capturing apparatus comprising
optics for forming an image on an image plane;
an image sensor arranged at the image plane and arranged to transform the image to an image signal;
an image analyzer arranged to receive the image signal forming an initial image, to find at least one object in the initial image, and to determine at least one zoom area for each found object;
an image cut generator arranged to define a result image to comprise at least one of the at least one determined zoom areas; and
a storage memory arranged to store image data of the defined result image.

11. The apparatus according to claim 10, further comprising a user interface, the user interface is arranged to present image data of the determined at least one zoom areas, and to receive a selection of at least one of the at least one zoom areas, such that the image cut generator is enabled to define the result image according to the selection.

12. The apparatus according to claim 10, wherein the optics comprises a focusing mechanism arranged to determine at least one object in the initial image on which focus settings are calculated, and to adjust focus of the optics according to the focus settings, wherein the apparatus further comprises a selection mechanism arranged to make a selection of at least one of the at least one zoom areas based on the object(s) on which the focus settings are calculated, such that the storage memory is enabled to store the result image according to the selection.

13. The apparatus according to claim 10, wherein the optics comprises a focusing mechanism, and wherein the image analyzer is further arranged to provide a focusing parameter to the focusing mechanism for controlling the focusing mechanism, wherein the focusing parameter is based on object(s) found by the image analyzer.

14. The apparatus according to claim 10, wherein the optics comprises an optical zoom mechanism, and wherein the image analyzer is further arranged to provide an optical zoom parameter to the optical zoom mechanism for controlling the optical zoom mechanism, wherein the optical zoom parameter is based on object(s) found by the image analyzer.

15. The apparatus according to claim 10, wherein the image cut generator is arranged to control any of:
an optical zoom, a digital zoom, an image crop mechanism, and a user interface arranged to provide instructions to a user to adjust image capturing direction.

16. The apparatus according to claim 10, wherein the image analyzer is further arranged to apply a composition rule to the at least one object found in the initial image.

17. A computer readable medium comprising a computer program comprising instruction, which when executed on a processor cause the processor to perform image capturing, the capturing comprising
analyzing an image signal being transformed from an optical image to form an initial image, wherein the analyzing comprises
finding at least one object of the initial image, and
determining at least one zoom area for each found object;
defining a result image to comprise at least one of the at least one determined zoom areas; and
storing image data of the defined result image.

18. The computer readable medium according to claim 17, wherein the capturing further comprises
presenting image data of the determined at least one zoom areas through a user interface; and
receiving a selection of at least one of the at least one zoom areas through the user interface,
wherein the defining of the result image is made according to the selection.

19. The computer readable medium according to claim 18, wherein the presenting comprises enabling of browsing among image data of the determined at least one zoom areas.

20. The computer readable medium according to claim 18, wherein the presenting comprises presenting the initial image of the image signal with indications on the determined at least one zoom areas.

21. The computer readable medium according to claim 17, wherein the capturing further comprises selecting at least one of the at least one zoom areas based on a focusing parameter of a focusing mechanism of optics forming the optical image, wherein the defining of the result image data is made according to the selection.

22. The computer readable medium according to claim 17, wherein the defining comprises defining result images of each of the determined at least one zoom areas.

23. The computer readable medium according to claim 17, wherein the storing further comprises encoding the result image.

24. The computer readable medium according to claim 17, wherein the defining of the result image comprises any of:
optical zooming, digital zooming, cropping, and providing instructions to a user to adjust image capturing direction.

25. The computer readable medium according to claim 17, wherein the determining of the zoom area comprises applying a composition rule to the at least one object found in the initial image.
